(19) United States
(12) Patent Application Publication
(10) Pub. No.: US 2013/0009787 A1
(43) Pub. Date: Jan. 10, 2013

(54) SYSTEMS AND METHODS FOR USE IN COMMUNICATING WITH UTILITY DEVICES

(76) Inventors: Bradley Richard Ree, Cumming, GA (US); Bruce Bharat, Smyrna, GA (US)

(21) Appl. No.: 13/178,045

(22) Filed: Jul. 7, 2011

(51) Int. Cl. G08C 15/06

(52) U.S. Cl. 340/870.02

(57) ABSTRACT

Systems and methods for use in communicating with utility devices. A utility meter receives one or more messages from one or more utility devices. Each message corresponds to a communication protocol of a plurality of communication protocols. The utility meter selects a communication protocol based on at least one message of the received messages. The utility meter communicates with at least a portion of the utility devices using the selected communication protocol.

### BACKGROUND OF THE INVENTION

The subject matter disclosed herein relates generally to utility systems and, more specifically, to systems and methods for use in communicating with utility devices.

At least some known utility systems include utility devices, such as gateways, appliances, load controllers, and/or utility displays, that are capable of communicating with a utility meter that may be referred to as a “smart meter.” Such utility devices may exchange, with the utility meter, information such as utility usage data and/or utility pricing data.

Communication in at least some known utility systems is performed according to a communication protocol that defines, for example, the structure of messages used to exchange utility information. The preferred communication protocol may change over time. For example, the communication protocol may be revised to support additional messages and/or additional fields within existing messages. As such, a utility meter that supports only one communication protocol may not be capable of communicating with utility devices that are configured to communicate using another communication protocol.

### BRIEF DESCRIPTION OF THE INVENTION

In one aspect, a system for use in communicating with one or more utility devices is provided. The system includes a memory device, a communication interface, and a processor coupled to the memory device and the communication interface. The memory device is configured to store first computer-executable instructions for communicating using a first communication protocol and second computer-executable instructions for communicating using a second communication protocol. The communication interface is configured to receive a message from a utility device. The processor is programmed to select a communication protocol from the first communication protocol and the second communication protocol based on the received message, and to execute the computer-executable instructions corresponding to the selected communication protocol to communicate with the utility device via the communication interface using the selected communication protocol.

In another aspect, a method for use in communicating with one or more utility devices is provided. The method includes receiving, by a utility meter, a plurality of messages from a plurality of utility devices. Each message corresponds to a communication protocol of a plurality of communication protocols. A communication protocol is selected by the utility meter based on at least one message of the received messages. The utility meter communicates with at least a portion of the utility devices using the selected communication protocol.

In yet another aspect, one or more non-transitory computer-readable storage media having computer-executable instructions embodied thereon are provided. When executed by at least one processor, the computer-executable instructions cause the at least one processor to receive one or more connection requests from one or more utility devices, wherein each connection request corresponds to a communication protocol of a plurality of communication protocols, to select a communication protocol based on at least one connection request of the received connection requests, and to communicate with at least a portion of the utility devices using the selected communication protocol.

### BRIEF DESCRIPTION OF THE DRAWINGS

FIG. 1 is a block diagram of an exemplary computing device;

FIG. 2 is block diagram of an exemplary utility system including a utility meter and a plurality of utility devices, such as an energy service portal, that are coupled in communication via a network; and

FIG. 3 is a flowchart of an exemplary method that may be used with the system shown in FIG. 2.

### DETAILED DESCRIPTION OF THE INVENTION

The embodiments described herein enable supporting multiple communication protocols using the same hardware in a utility meter. In exemplary embodiments, a utility meter includes multiple network stacks, each of which corresponds to a communication protocol. A protocol detector or “multiplexor” software component communicates with a communication interface (e.g., a radio) and determines which communication protocol is used by one or more utility devices (e.g., an energy service portal and/or an energy service interface). The utility meter routes data exchanged between the meter and the utility device through the network stack that corresponds to the communication protocol used by the utility device. The utility meter may further include an application programming interface (API) component that provides protocol-independent communication functions to software applications executed by the utility meter.

Accordingly, the embodiments provided facilitate establishing communication between a utility meter and one or more utility devices without requiring manual configuration of hardware or software based on the communication protocol used by the utility devices. Further, when communication using a selected communication protocol is terminated, the process of determining which communication protocol to use may be repeated. Such embodiments further enable the utility meter to automatically accommodate the replacement of one utility device with another utility device that uses a different communication protocol.

As used herein, the term “utility device” refers to one or more physical devices that uses, processes, generates, communicates, and/or presents utility information, such as utility consumption, utility pricing, utility demand, and/or any other information suitable for use with the methods described herein. Embodiments are described herein with reference to utility networks and utility equipment for electricity. However, embodiments of the present invention may be used in connection with any type of utility service. Further, embodiments are described in the context of smart utility devices communicating using communication protocols, such as Smart Energy Profile 1.0 and Smart Energy Profile 2.0, defined by the ZigBee® specification. ZigBee is a registered trademark of ZigBee Alliance, San Ramon, Calif. 94583. Although specific communication protocols are referenced, it is contemplated that the methods described herein may be practiced with any communication protocols.

An exemplary technical effect of the methods, systems, and apparatus described herein includes at least one of (a) receiving, by a utility meter, one or more messages from one or more utility devices, wherein each message corresponds to a communication protocol of a plurality of communication protocols; (b) selecting, by the utility meter, a first communication protocol based on at least one message of the received messages; (c) communicating, by the utility meter, with at least a portion of the utility devices using the first communication protocol; (d) determining, by the utility meter, that communication using the first communication protocol is terminated; (e) selecting, by the utility meter, a second communication protocol based on a one or more messages received from one or more utility devices; and (f) communicating, by the utility meter, with at least a portion of the utility devices using the second communication protocol.

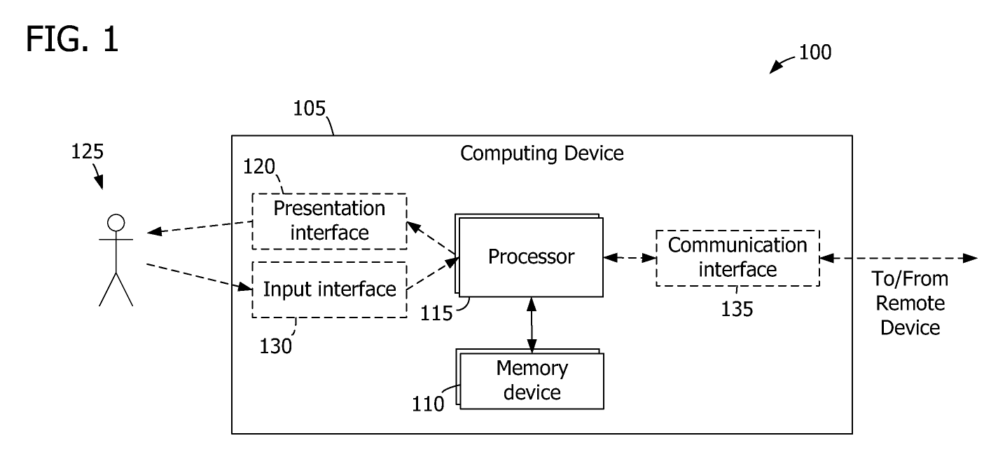

FIG. 1 is a block diagram of an exemplary computer system 100 that includes a computing device 105 including a memory device 110 that may be used to communicate utility information. In the exemplary embodiment, computing device 105 includes a processor 115 that is coupled to memory device 110 for executing programmed instructions. In some embodiments, computer-executable instructions are stored in memory device 110. Alternatively, computer-executable instructions may be retrieved from another device via a computer network. Computing device 105 is programmable to perform one or more operations described herein by programming processor 115. For example, processor 115 may be programmed by encoding an operation as one or more computer-executable instructions and providing the computer-executable instructions in memory device 110. Processor 115 may include one or more processing units (e.g., in a multi-core configuration).

Processor 115 may include, but is not limited to, a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a non-transitory computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

In the exemplary embodiment, memory device 110 is one or more devices that enable information, such as executable instructions and/or other data, to be selectively stored and retrieved. Memory device 110 may include one or more computer readable media, such as, without limitation, dynamic random access memory (DRAM), static random access memory (SRAM), a solid state disk, and/or a hard disk. Memory device 110 may be configured to store, without limitation, executable instructions and/or any other type of data suitable for use with the methods described herein.

In the exemplary embodiment, computing device 105 includes a presentation interface 120 that is coupled to processor 115. Presentation interface 120 is configured to output (e.g., display, print, and/or otherwise output) information, such as, but not limited to, utility information, utility device information, and/or network information (e.g., available communication protocols and/or a communication protocol currently in use), to a user 125. For example, presentation interface 120 may include a display adapter (not shown in FIG. 1) that is coupled to a display device, such as a cathode ray tube (CRT), a liquid crystal display (LCD), an organic LED (OLED) display, and/or an “electronic ink” display. In some embodiments, presentation interface 120 includes more than one display device. In addition to, or in the alternative, presentation interface 120 may include a printer. In some embodiments, presentation interface 120 resides remotely to computing device 105. For example, computing device 105 may communicate with a server that is configured to exchange information with computing device 105 and user 125.

In some embodiments, computing device 105 includes an input interface 130 that receives input from user 125. Input interface 130 may be local to computing device 105 and/or may be connected to user 125 through another device that is accessible to both computing device 105 and user 125. Input interface 130 may be configured to receive a selection or entry of communication protocol selection criteria, a weight associated with one or more utility devices and/or communication protocols, configuration data (e.g., one or more threshold values) and/or any other information suitable for use with the methods and systems described herein.

In the exemplary embodiment, input interface 130 is coupled to processor 115 and may include, for example, a keyboard, a pointing device, a mouse, a stylus, a touch sensitive panel (e.g., a touch pad or a touch screen), a gyroscope, an accelerometer, a position detector, and/or an audio input interface. A single component, such as a touch screen, may function as both a display device of presentation interface 120 and as input interface 130.

Computing device 105 may include a communication interface 135 coupled to processor 115. Communication interface 135 is coupled in communication with a remote device, such as another computing device 105. For example, communication interface 135 may include, without limitation, a wired network adapter, a wireless network adapter, and/or a mobile telecommunications adapter.

In an exemplary embodiment, computing device 105 stores in memory device 110, and/or is operable to access via communication interface 135 (e.g., from another computing device 105), data for use in communicating utility information. For example, such data may include, but is not limited to only including, communication protocol selection criteria, weights associated with one or more utility devices and/or communication protocols, configuration data (e.g., one or more threshold values), utility consumption, utility pricing, and/or utility demand.

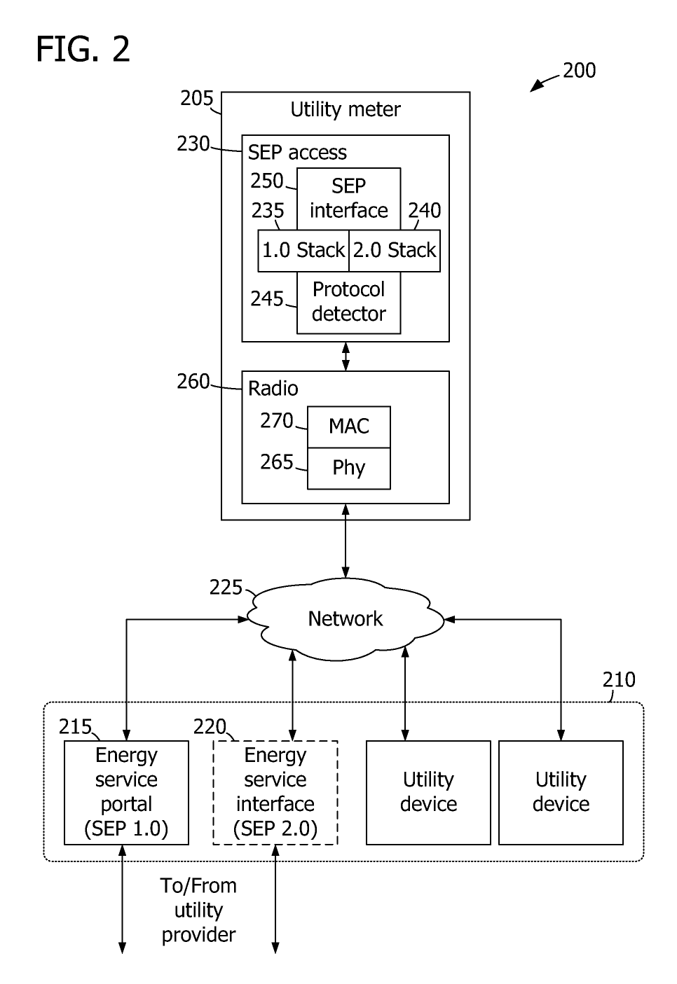

FIG. 2 is block diagram of an exemplary utility system 200 including a utility meter 205 and a plurality of utility devices 210, such as an energy service portal (ESP) 215 and/or an energy service interface (ESI) 220, that are coupled in communication via a network 225. Network 225 may include, without limitation, a wireless LAN (WLAN), a mesh network, a local area network (LAN), a wide area network (WAN), the Internet, and/or a virtual private network (VPN). In some embodiments, network 225 includes a home area network (HAN).

In exemplary embodiments, utility meter 205 and utility devices 210 are and/or include computing devices 105 (shown in FIG. 1). While certain operations are described below with respect to particular computing devices 105, it is contemplated that any computing device 105 may perform any of the described operations. Moreover, in the exemplary embodiment, each computing device 105 is coupled to network 225 via communication interface 135 (shown in FIG. 1). In an alternative embodiment, one or more utility devices 210 are integrated with utility meter 205.

ESP 215 and ESI 220 exchange historical, current, and/or predicted utility information, such as utility rates, utility demand, and/or utility consumption, with a utility provider. Accordingly, ESP 215 and/or ESI 220 may act as a gateway between system 200 and a network operated by a utility provider. Such networks may include, without limitation, an advanced metering infrastructure (AMI) network. In some embodiments, ESP 215 and/or ESI 220 is located within utility meter 205, while in some embodiments ESP 215 and/or ESI 220 is a separate device.

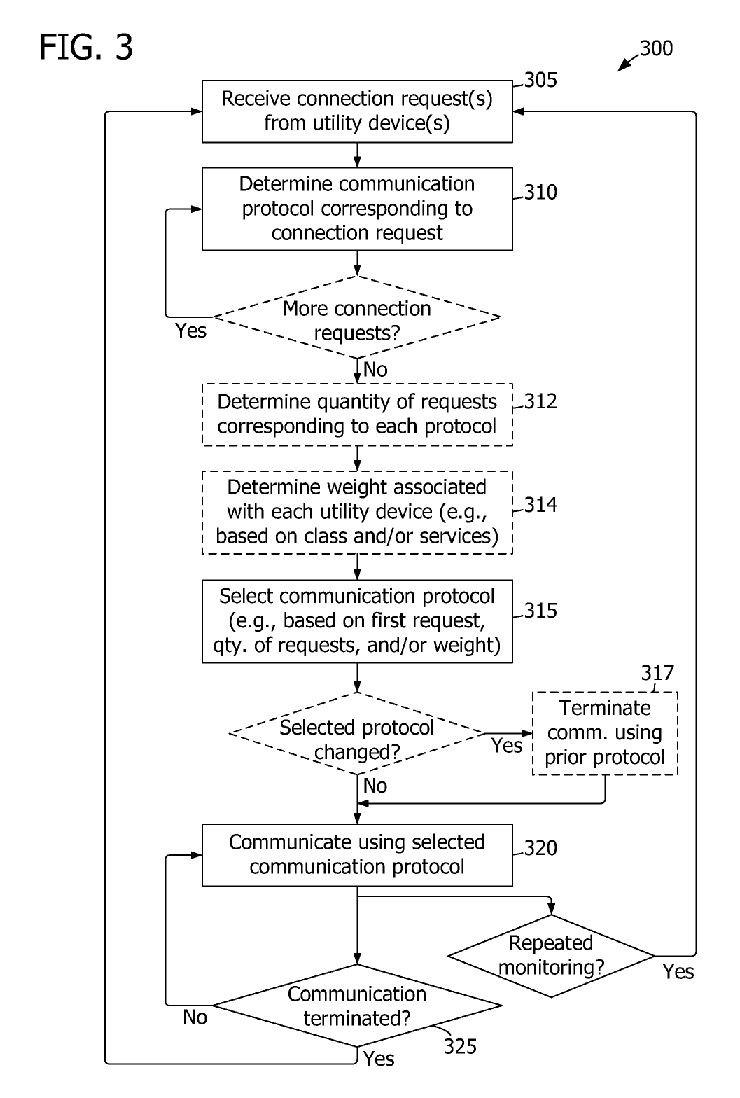

FIG. 3 is a flowchart of an exemplary method 300 that may be used with system 200 (shown in FIG. 2). Referring to FIGS. 2 and 3, in exemplary embodiments, method 300 is executed by utility meter 205. In addition, or alternative to, any portion of the operations described may be performed by ESP 215, ESI 220, one or more utility devices 210, and/or any other computing device 105 (shown in FIG. 1).

In exemplary embodiments, utility meter 205 includes, stored in memory device 110, software components such as a Smart Energy Profile (SEP) access component 230. SEP access component 230, and the subcomponents thereof described below, include computer-executable instructions that, when executed by a processor (e.g., processor 115, shown in FIG. 1), cause the processor to perform one or more operations described herein.

In exemplary embodiments, SEP access component 230 includes a plurality of network stacks, such as an SEP 1.0 stack 235 and an SEP 2.0 stack 240. SEP 1.0 stack 235 includes first computer-executable instructions for communicating with utility devices 210 using a first communication protocol, such as SEP 1.0. SEP 2.0 stack 240 includes second computer-executable instructions for communicating with utility devices 210 using a second communication protocol, such as SEP 2.0. Although two specific communication protocols are described, it is contemplated that the methods provided herein may be practiced with any quantity and any type of communication protocols.

SEP access component 230 also includes a protocol detector 245 and an SEP interface 250. Protocol detector 245 includes logic for determining which of the available communication protocols (e.g., communication protocols for which a corresponding network stack is available) to use. SEP interface 250 provides protocol-independent communication functions to software applications executed by utility meter 205. Accordingly, other software components executed by utility meter 205 may communicate with utility devices 210 without any protocol-specific logic, enabling such software components to function when protocol detector 245 switches from one communication protocol to another communication protocol.

Protocol detector 245 may use one or more methods to detect the proper protocol. For example, SEP 1.0 uses a Zigbee protocol, while SEP 2.0 uses Internet Protocol (IP). These packets contain unique payloads that may be inspected to identify the protocol being used. However, in another embodiment, the message may be sent to a plurality of network stacks executed by utility meter 205. Whichever stack is capable of processing the packet (e.g., without reporting an error) would then configure protocol detector 245. Conversely, a network stack that could not successfully process the packet may also configure protocol detector 245 (e.g., by configuring protocol detector 245 to use the other network stack). In another embodiment, the protocol stacks may employ different security techniques (e.g., authorization, authentication, decoding, and/or decryption). Thus, a successful application of a security technique (e.g., decoding) of the received packet by one of the network stacks may be used to configure protocol detector 245.

SEP access component 230 may communicate with utility devices 210 via one or more communication interfaces 135 (shown in FIG. 1), such as a radio 260, that includes a physical component 265 and a media access control (MAC) component 270. In exemplary embodiments, physical component 265 corresponds to Layer 1 of the Open Systems Interconnection (OSI) model, and MAC component 270 corresponds to Layer 2 of the OSI model. Protocol detector 245 may interact with radio 260 to determine which communication protocol to use, as described in more detail below. Once a protocol is selected, protocol detector 245 may pass data between radio 260 (e.g., via MAC component 270) and the network stack (e.g., SEP 1.0 stack 235 or SEP 2.0 stack 240) that corresponds to the selected communication protocol.

In exemplary embodiments, utility meter 205 receives 305 one or more messages, such as connection requests, from one or more utility devices 210. Each message corresponds to a particular communication protocol of a plurality of communication protocols (e.g., SEP 1.0 and/or SEP 2.0). In some embodiments, the messages are connection requests from a utility device 210, such as ESP 215. Alternatively, utility meter 205 may transmit (e.g., broadcast) a discovery request, and each utility device 210 may respond by transmitting a discovery response indicating the presence of utility device 210.

Utility meter 205 determines 310 the communication protocol that corresponds to each received message. In exemplary embodiments, the communication protocol is determined 310 based on one or more predetermined protocol recognition rules stored by utility meter 205 and applied by protocol detector 245. For example, a protocol recognition rule may specify the length of a message (e.g., a connection request), the length of a field within a message in a communication protocol. Lengths may be expressed as a quantity of bits, bytes, fields, and/or any other measure suitable for indicating the size of a message and/or a field. Similarly, a protocol recognition rule may specify the position of an element (e.g., a character, a string, and/or a field) within a message. For example, the position may be expressed as a byte offset, such as the quantity of bytes separating the element from the beginning of the message and/or from the beginning of a field within the message. Accordingly, protocol detector 245 may determine 310 the communication protocol that corresponds to a message at least in part by comparing such a length or position that is associated with the received message to a corresponding length or position in a protocol recognition rule.

In addition, or alternative to, in some embodiments, the message includes a protocol indicator (e.g., an identifier associated with a communication protocol) at a predetermined position. In such embodiments, protocol detector 245 determines 310 the communication protocol based at least in part on the protocol indicator, such as by selecting a communication protocol associated with the protocol identifier.

Protocol detector 245 selects 315 a communication protocol to use for communicating with utility devices 210 based on one or more of the received messages. In some embodiments, protocol detector 245 selects 315 the communication protocol that corresponds to the message that is received 305 first in time (e.g., prior to receiving 305 any other messages).

In other embodiments, protocol detector 245 selects 315 a communication protocol based on a plurality of messages. In one embodiment, protocol detector 245 determines 312 the quantity of messages and/or the quantity of utility devices 210 corresponding to each communication protocol. For example, utility meter 205 may receive an SEP 1.0 connection request from each of three utility devices 210 (a total of three SEP 1.0 messages) and an SEP 2.0 connection request from each of two utility devices 210 (a total of two SEP 2.0 messages). In such an embodiment, protocol detector 245 selects 315 the communication protocol (e.g., SEP 1.0) that is associated with the greatest quantity of messages and/or the greatest quantity of utility devices 210 among the communication protocols.

In another embodiment, protocol detector 245 determines 314 a weight associated with each utility device 210 from which a message has been received 305, determines a first utility device 210 associated with a highest weight among the utility devices 210, and selects 315 the communication protocol corresponding to the message received 310 from the first utility device 210. The weight of a utility device 210 may be determined 314 based on any factor that is relevant to the operation and/or performance of system 200. For example, each utility device 210 may be associated with a device class, such as energy service portal (ESP), energy service interface (ESI), gateway, utility display, load controller, appliance, climate control device, light control, demand response device, thermostat, and/or vehicle charger. The weight may be determined 314 by applying to each utility device 210 a weight equal to a weight associated with the associated device class.

In another example, protocol detector 245 determines 314 the weight associated with a utility device 210 based on the services provided by the utility device 210. For example, protocol detector 245 may receive from each utility device 210 (e.g., within a message such as a connection request) one or more services provided by the utility device 210. Services may include, for example, communication with a network operated by a utility provider, demand response, sensor output, load control, and/or any other service relevant to operation and/or performance of system 200. Each service may be associated with a weight, and the weight of a utility device 210 may be determined 314 at least in part by combining (e.g., summing, averaging, and/or multiplying) the weights associated with the services provided by the utility device 210.

Further, in some embodiments, multiple factors may be used to select 315 the communication protocol. For example, protocol detector 245 may combine (e.g., sum, average, and/or multiply) the weights associated with the utility devices 210 from which a message corresponding to a particular communication protocol has been received 305. The combined weight may be multiplied by the quantity of messages corresponding to the communication protocol to calculate a score for the communication protocol, and the communication protocol having the greatest score may be selected 315.

When protocol detector 245 has selected 315 a communication protocol, utility meter 205 communicates 320 with at least a portion of utility devices 210 using the selected communication protocol. For example, utility meter 205 may communicate 320 with all utility devices 210 that correspond to (e.g., support) the selected communication protocol, such as by transmitting a positive (e.g., connection acceptance) response to the connection requests received 305 from such utility devices 210. In exemplary embodiments, utility meter 205 communicates 320 at least in part by executing computer-executable instructions corresponding to the selected communication protocol. For example, utility meter 205 may execute the computer-executable instructions included in SEP 1.0 stack 235 when the SEP 1.0 protocol is selected 315.

In some embodiments, utility meter 205 repeatedly (e.g., periodically, continuously, and/or on demand) determines 325 whether communication 320 with one or more utility devices 210 using the selected communication protocol is terminated. For example, utility meter 205 may determine 325 that a connection to a utility device 210 is inoperable and/or that the utility device 210 does not respond to one or more messages, such as a status request and/or a ping message. If communication 320 is not terminated, utility meter 205 continues communicating 320 using the selected communication protocol. If communication 320 is terminated, utility meter 205 proceeds to re-execute method 300, beginning with receiving 305 messages (e.g., connection requests) from utility devices 210. In such an embodiment, utility meter 205 may select 315 a different communication protocol than was selected 315 in the previous execution of method 300. For example, if ESP 215 is replaced by ESI 220, system 200 will include one less utility device 210 communicating using SEP 1.0 and one more utility device 210 communicating using SEP 2.0. Accordingly, protocol detector 245 may select 315 SEP 2.0 based at least in part on a message received 305 from ESI 220 and communicate 320 with utility devices 210 using SEP 2.0. Such embodiments facilitate switching from one protocol to another protocol without reconfiguring utility meter 205.

In addition, or alternative to, protocol detector 245 may repeatedly (e.g., periodically, continuously, and/or on demand) monitor network 225 while utility meter 205 is communicating 320 with utility devices 210 using the selected communication protocol. For example, if such repeated monitoring is enabled (e.g., via a configuration option), while utility meter 205 communicates 320 using a first communication protocol (e.g., SEP 1.0), protocol detector 245 may receive 305 one or more messages (e.g., connection requests) from utility devices 210 and select 315 a second communication protocol (e.g., SEP 2.0) based on the received message(s). In such an embodiment, if the second communication protocol is different from the first communication protocol, utility meter 205 terminates 317 communication 320 using the first communication protocol and communicates 320 with utility devices 210 using the second communication protocol. Such embodiments facilitate switching from one protocol to another protocol even in the absence of a communication failure (e.g., as additional utility devices 210 are added to system 200).

Embodiments described herein facilitate supporting multiple communication protocols using a single physical communication interface in a utility meter. The utility meter may be programmed to automatically select a communication protocol based on various criteria and to communicate with utility devices using the selected communication protocol. Accordingly, manual configuration of the utility meter may be reduced and/or eliminated. Further, as utility devices are added to the network and/or as communication with one or more utility devices is terminated, the utility meter may repeat the protocol selection process, potentially selecting a different communication protocol that is more appropriate for the current state of the network.

Embodiments described herein may be performed using a computer-based and/or computing-device-based operating environment as described herein. A computer or computing device may include one or more processors or processing units, system memory, and some form of non-transitory computer-readable media. Exemplary non-transitory computer-readable media include flash memory drives, hard disk drives, digital versatile discs (DVDs), compact discs (CDs), floppy disks, and tape cassettes. By way of example and not limitation, computer-readable media comprise computer storage media and communication media. Computer-readable storage media are non-transitory and store information such as computer-readable instructions, data structures, program modules, or other data. Communication media typically embody computer-readable instructions, data structures, program modules, or other data in a modulated data signal such as a carrier wave or other transport mechanism and include any information delivery media. Combinations of any of the above are also included within the scope of computer-readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The methods and systems described herein are not limited to the specific embodiments described herein. For example, components of each system and/or steps of each method may be used and/or practiced independently and separately from other components and/or steps described herein. In addition, each component and/or step may also be used and/or practiced with other apparatus and methods.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While the invention has been described in terms of various specific embodiments, those skilled in the art will recognize that the invention may be practiced with modification within the spirit and scope of the claims.

What is claimed is:

1. A system for use in communicating with one or more utility devices, said system comprising:
a memory device configured to store:
first computer-executable instructions for communicating using a first communication protocol; and
second computer-executable instructions for communicating using a second communication protocol;
a communication interface configured to receive a message from a utility device; and
a processor coupled to said memory device and said communication interface, wherein said processor is programmed to:
select a communication protocol from the first communication protocol and the second communication protocol based on the received message;
execute the computer-executable instructions corresponding to the selected communication protocol to communicate with the utility device via said communication interface using the selected communication protocol.

2. A system according to claim 1, wherein after selecting a communication protocol, said processor is further programmed to communicate with a plurality of utility devices via said communication interface using the selected communication protocol.

3. A system according to claim 1, wherein the utility device is a first utility device of a plurality of utility devices, wherein said communication interface is further configured to receive a message from each utility device of the plurality of utility devices, and wherein said processor is further programmed to select a communication protocol based on a weight associated with the first utility device.

4. A system according to claim 3, wherein the first utility device is associated with a device class, and wherein said processor is further programmed to determine the weight based on the device class associated with the first utility device.

5. A system according to claim 1, wherein said processor is programmed to select a communication protocol at least in part by:
processing the received message using the first computer-executable instructions; and
selecting the first communication protocol when the received message is successfully processed by the first computer-executable instructions.

6. A system according to claim 1, wherein said processor is programmed to select a communication protocol at least in part by determining a communication protocol corresponding to the received message based on one or more protocol indicators within the received message.

7. A system according to claim 1, wherein the received message is a first message received from a first utility device and the selected communication protocol is the first communication protocol, and wherein said processor is further programmed to:
determine that communication with the first utility device using the first communication protocol is terminated;
select the second communication protocol based on a second message received from a second utility device by said communication interface; and
execute the computer-executable instructions corresponding to the second communication protocol to communicate with the second utility device via said communication interface using the second communication protocol.

8. A method for use in communicating with one or more utility devices, said method comprising:
receiving, by a utility meter, a plurality of messages from a plurality of utility devices, wherein each message corresponds to a communication protocol of a plurality of communication protocols;
selecting, by the utility meter, a communication protocol based on at least one message of the received messages; and
communicating, by the utility meter, with at least a portion of the utility devices using the selected communication protocol.

9. A method according to claim 8, wherein selecting a communication protocol comprises selecting a communication protocol that corresponds to a first message that is received prior to receiving the messages other than the first message.

10. A method according to claim 8, wherein selecting a communication protocol comprises:
determining a quantity of messages corresponding to each communication protocol of the communication protocols; and
selecting a communication protocol associated with a greatest quantity of messages among the communication protocols.

11. A method according to claim 8, wherein selecting a communication protocol comprises:
determining a first utility device associated with a highest weight among the utility devices; and
selecting a communication protocol corresponding to a message received from the first utility device.

12. A method according to claim 11, wherein determining a first utility device associated with a highest weight among the utility devices comprises determining a weight associated with each utility device based on a device class associated with the utility device.

13. A method according to claim 11, wherein determining a first utility device associated with a highest weight among the utility devices comprises:
receiving from each utility device one or more services provided by the utility device; and
determining a weight associated with each utility device based on the services provided by the utility device.

14. A method according to claim 8, wherein selecting a communication protocol based on at least one message of the received messages comprises selecting a first communication protocol based on at least one connection request of a first plurality of connection requests, said method further comprising:
receiving, by the utility meter, a second plurality of connection requests while communicating with the portion of the utility devices using the first communication protocol;
selecting, by the utility meter, a second communication protocol based on at least one connection request of the second plurality of connection requests;
terminating, by the utility meter, communication that uses the first communication protocol; and
communicating, by the utility meter, with at least a portion of the utility devices using the second communication protocol.

15. One or more non-transitory computer-readable storage media having computer-executable instructions embodied thereon, wherein when executed by at least one processor, the computer-executable instructions cause the processor to:
receive one or more connection requests from one or more utility devices, wherein each connection request corresponds to a communication protocol of a plurality of communication protocols;
select a communication protocol based on at least one connection request of the received connection requests; and
communicate with at least a portion of the utility devices using the selected communication protocol.

16. One or more storage media according to claim 15, wherein the computer-executable instructions further cause the processor to determine the communication protocol corresponding to each connection request based on at least one of the following: a length of the connection request, a length of a field within the connection request, and a byte offset within the connection request.

17. One or more storage media according to claim 15, wherein the computer-executable instructions cause the processor to select a communication protocol at least in part by selecting a communication protocol that corresponds to a first connection request that is received prior to receiving the connection requests other than the first connection request.

18. One or more storage media according to claim 15, wherein the computer-executable instructions cause the processor to select a communication protocol at least in part by:
determining a quantity of connection requests corresponding to each communication protocol of the communication protocols; and
selecting a communication protocol associated with a greatest quantity of connection requests among the communication protocols.

19. One or more storage media according to claim 15, wherein the computer-executable instructions cause the processor to select a communication protocol at least in part by:
determining a first utility device associated with a highest weight among the utility devices; and
selecting a communication protocol corresponding to a connection request received from the first utility device.

20. One or more storage media according to claim 15, wherein the plurality of connection requests is a first plurality of connection requests, and the selected communication protocol is a first communication protocol, wherein the computer-executable instructions further cause the processor to:
receive a second plurality of connection requests from a plurality of utility devices based on determining that communication using the first communication protocol is terminated;
select a second communication protocol based on at least one connection request of the second plurality of connection requests; and
communicate with at least a portion of the utility devices using the second communication protocol.
